(19) United States
(12) Patent Application Publication
(10) Pub. No.: US 2014/0231189 A1
(43) Pub. Date: Aug. 21, 2014

(54) ELECTRIC CALIPER BRAKE

(71) Applicant: MANDO CORPORATION, Pyeongtaek-si (KR)

(72) Inventors: Joong-Gwun PARK, Yongin-si (KR); Jae-Jin HUR, Pyeongtaek-si (KR)

(73) Assignee: MANDO CORPORATION, Pyeongtaek-si (KR)

(21) Appl. No.: 14/162,314

(22) Filed: Jan. 23, 2014

(30) Foreign Application Priority Data
Feb. 18, 2013 (KR) 10-2013-0016672

(51) Int. Cl. F16D 65/14; F16D 65/00

(52) U.S. Cl. CPC F16D 65/14; F16D 65/0068; F16D 2127/02
USPC 188/72.3

(57) ABSTRACT

Disclosed herein is an electric caliper brake. The electric caliper brake includes a carrier to which a pair of pad plates are mounted, a caliper housing which is slidably mounted to the carrier and is provided with a cylinder containing a piston, a spindle unit including a screw which penetrates a rear portion of the cylinder and is configured to rotate by receiving rotational force from an actuator and a nut which is screw-engaged with the screw in the piston and configured to move forward and backward according to rotation of the screw so as to pressurize the piston and release pressurization, a fixing element fixed to a rear inner peripheral surface of the piston, and an elastic element having one end supported by the nut and the other end supported by the fixing element and configured to return the piston to an original position when braking is released.

### CROSS-REFERENCE TO RELATED APPLICATION

This application claims the benefit of Korean Patent Application No. 2013-0016672, filed on Feb. 18, 2013 in the Korean Intellectual Property Office, the disclosure of which is incorporated herein by reference.

### BACKGROUND

1. Field

Embodiments of the present invention relate to an electric caliper brake capable of forcibly rolling back a piston by elastic restoring force of an elastic element when braking is released.

2. Description of the Related Art

In general, an electric caliper brake is a brake system in which an actuator configured to operate by electricity is added to a typical hydraulic disc brake.

An example of an electric disc brake system (“electric caliper brake” hereinafter) is disclosed in Korean Patent Registration No. 10-1184575. An electric caliper brake disclosed in this patent literature comprises a disc configured to rotate together with a wheel, a carrier to which a pair of pad plates configured to move forward and backward to pressurize the disc are mounted, a caliper housing which is slidably mounted to the carrier and is provided with a cylinder containing a piston configured to move linearly by a brake oil pressure, a spindle unit configured to pressurize the piston, and a motor and a speed reducer which are configured to transmit rotational force to the spindle unit.

The electric caliper brake carries out braking operation by pressurizing the piston by a brake oil pressure or parking operation by pressurizing the piston by the spindle unit which receives rotational force from the motor and converts rotational movement into linear movement. Further, the electric caliper brake is structured to roll back the piston using a sealing element and a roll-back chamfer in order to reduce a drag phenomenon that friction pads attached to a pair of pad plates frictionally contact the disc even after braking operation is completed.

FIG. 1 is a view illustrating a state of rolling back a piston using a sealing element and a roll-back chamfer in a conventional electric caliper brake.

Referring to FIG. 1, a sealing element 10 has a ring shape which is inserted into a ring-shaped roll-back chamfer 23 formed at an inner surface of a cylinder 21 of a caliper housing 20, and is interposed between an inner surface of the cylinder 21 and an outer surface of a piston 22. The sealing element 10 functions to prevent leakage of brake oil by sealing a gap between the inner surface of the cylinder 21 and the outer surface of the piston 22. The sealing element 10 also functions to return the piston 22 to an original position. As shown in the drawing, the piston 22 moves in a direction of an arrow A in braking operation. When the braking operation is completed, the piston 22, which has moved in a direction of the arrow A, retreats to the original position by elastic restoring force of the sealing element 10 which has been deformed. This is called “roll-back”.

However, in such a conventional electric caliper brake, returning movement of the piston 22 is performed only by elastic restoring force of the sealing element 10. Durability of the sealing element 10 may be deteriorated as the sealing element 10 is used for a long time, which may cause decrease in operational reliability, i.e., smooth return, of the piston 22, and thus may cause a drag phenomenon that friction pads 30 frictionally contact the disc D even after braking operation is completed. Additionally, because a deformable range L of the sealing element 10 is restrictive, a restoring distance of the piston 22 is short and accordingly there is a limitation in increasing a restoring distance of the piston 22.

### CITATION LIST

### Patent Literature

Korean Patent Registration No. 10-1184575 (registered on Sep. 14, 2012, Mando Corporation)

### SUMMARY

It is an aspect of the present invention to provide an electric caliper brake capable of preventing a drag phenomenon by forcibly rolling back a piston using an elastic element.

Additional aspects of the invention will be set forth in part in the description which follows and, in part, will be obvious from the description, or may be learned by practice of the invention.

In accordance with one aspect of the present invention, an electric caliper brake having a carrier to which a pair of pad plates configured to move forward and backward are mounted and a caliper housing which is slidably mounted to the carrier and is provided with a cylinder containing a piston configured to move linearly by a brake oil pressure, includes a spindle unit including a screw which penetrates a rear portion of the cylinder and is configured to rotate by receiving rotational force from an actuator and a nut which is screw-engaged with the screw in the piston and configured to move forward and backward according to rotation of the screw while being restricted in rotation so as to pressurize the piston and release pressurization, a fixing element fixed to a rear inner peripheral surface of the piston, and an elastic element having one end supported by the nut and the other end supported by the fixing element and configured to return the piston to an original position when braking is released. When the piston moves by a brake oil pressure, the elastic element may be compressed against the spindle unit which is kept stationary. When braking is released, the elastic element may return the piston using elastic restoring force thereof.

The nut may include a head part which contacts the piston and a rod which extends from the head part and is formed with a screw thread at an inner peripheral surface thereof so as to be screw-engaged with the screw. The one end of the elastic element may be supported by a rear wall of the head part, and the elastic element may surround the rod.

When the nut of the spindle unit moves forward and pressurizes the piston, the elastic element may move together with the piston. When the nut moves backward, the elastic element may be pressurized by the nut and may return the piston using elastic restoring force thereof.

The piston may be formed with a fixing groove along a rear inner peripheral surface thereof, and the fixing element may be a circlip which is fitted into the fixing groove in order to prevent the elastic element from being separated from the piston.

The elastic element may be a wave spring.

As described above, when a brake oil pressure is removed or the nut of the spindle unit is returned after braking is completed, the elastic element forcibly rolls back the piston to an original position using elastic force thereof, thereby preventing a drag phenomenon.

### BRIEF DESCRIPTION OF THE DRAWINGS

These and/or other aspects of the invention will become apparent and more readily appreciated from the following description of the embodiments, taken in conjunction with the accompanying drawings of which:

FIG. 1 is a view illustrating a state of rolling back a piston using a sealing element and a roll-back chamfer in a conventional electric caliper brake;

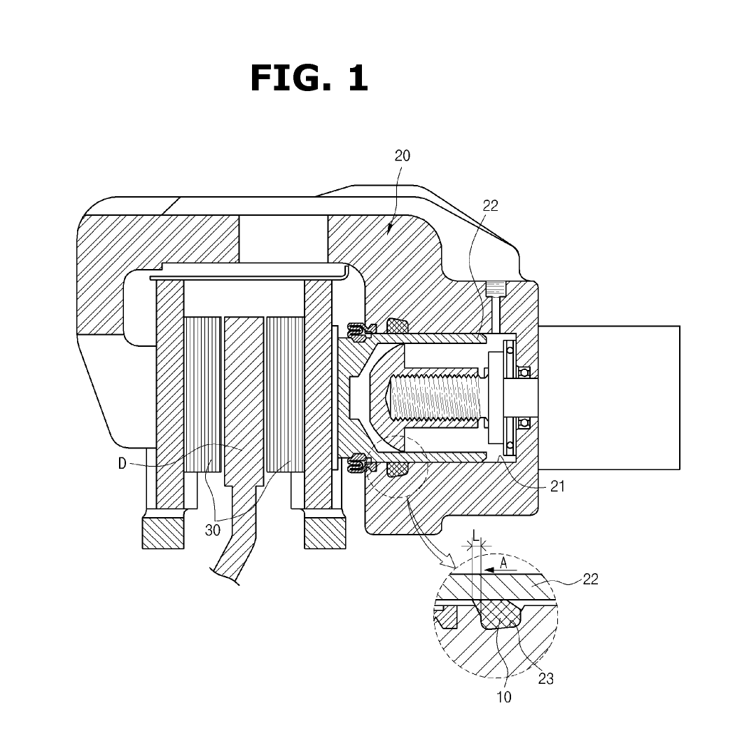

FIG. 2 is an exploded perspective view illustrating a coupling state of a piston, a spindle unit, an elastic element and a fixing element in an electric caliper brake according to an embodiment of the present invention;

FIG. 3 is a sectional view schematically illustrating the electric caliper brake according to an embodiment of the present invention;

FIG. 4 is a view illustrating a braking state by a brake oil pressure in the electric caliper brake according to an embodiment of the present invention; and

FIG. 5 is a view illustrating a parking state by a spindle unit in the electric caliper brake according to an embodiment of the present invention.

### DETAILED DESCRIPTION

Now, preferred embodiments of the present invention will be described in detail with reference to the annexed drawings.

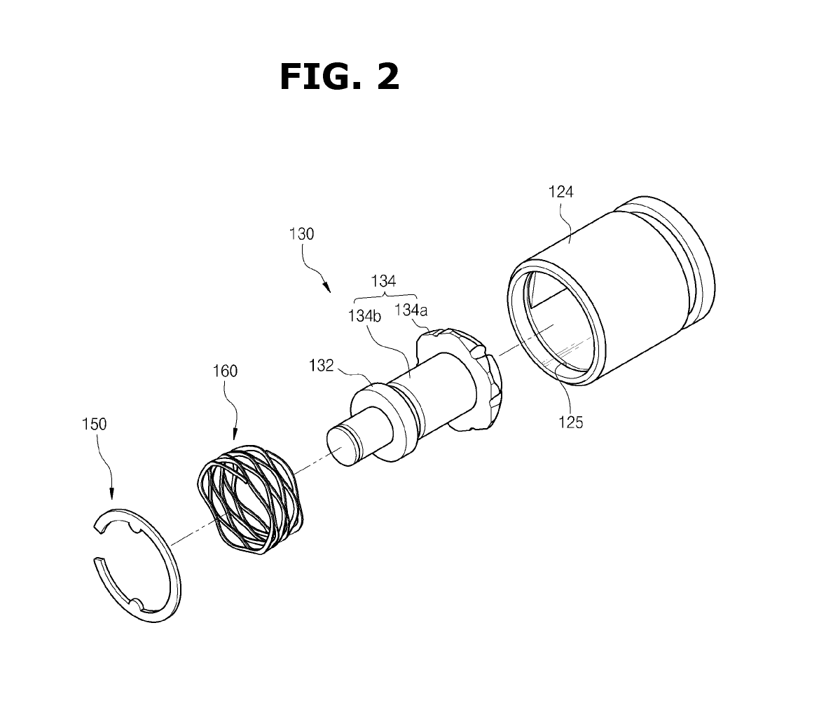

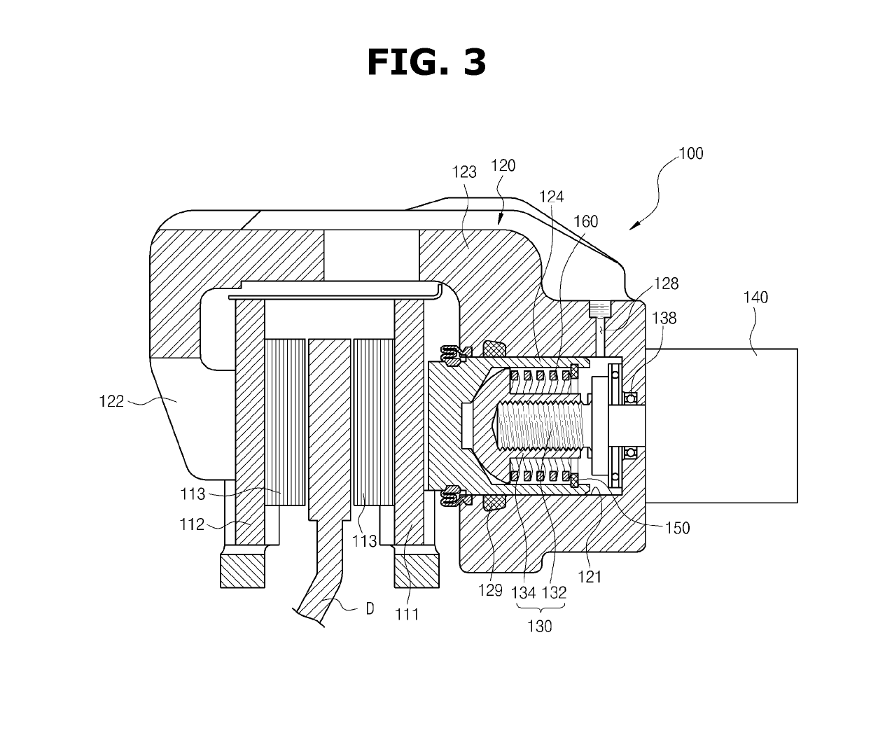

FIG. 2 is an exploded perspective view illustrating a coupling state of a piston, a spindle unit, an elastic element and a fixing element in an electric caliper brake according to an embodiment of the present invention, and FIG. 3 is a sectional view schematically illustrating an electric caliper brake according to an embodiment of the present invention.

Referring to FIGS. 2 and 3, an electric caliper brake 100 according to an embodiment of the present invention comprises a disc D configured to rotate together with a wheel (not shown) of a vehicle, a carrier (not shown) to which a pair of pad plates 111 and 112 configured to move forward and backward to pressurize the disc D are mounted, a caliper housing 120 which is slidably mounted to the carrier and is provided with a cylinder 121 containing a piston 124 configured to move linearly by a brake oil pressure, a spindle unit 130 configured to pressurize the piston 124, an actuator 140 configured to transmit rotational force to the spindle unit 130, an elastic element 160 which is provided in the piston 124 and configured to return the piston 124 to an original position when braking is released, and a fixing element 150 configured to prevent the elastic element 160 from being separated from the piston 124.

The pair of pad plates 111 and 112 includes an inner pad plate 111 with which the piston 124 comes into contact, and an outer pad plate 112 with which a finger part 122 (described later) of the caliper housing 120 comes into contact. The pair of pad plates 111 and 112 are mounted to the carrier (not shown) fixed to a car body and are configured to move toward or away from both lateral surfaces of the disc D. Friction pads 113 are attached to the respective surfaces, which face the disc D, of the pad plates 111 and 112.

The caliper housing 120 is slidably mounted to the carrier. In detail, the caliper housing 120 includes a cylinder 121, a finger part 122 and a body part 123 to connect the cylinder 121 and the finger part 122. The spindle unit 130 is mounted to a rear portion of the cylinder 121, and the piston 124 is linearly movably mounted in the cylinder 121. The finger part 122 is formed at a front portion of the caliper housing 120 and is bent downward to operate the outer pad plate 112. The cylinder 121, the finger part 122 and the body part 123 are formed integrally with each other.

The caliper housing 120 is formed with an oil port 128 through which brake oil flows into the cylinder 121 in order to apply a brake oil pressure. A sealing element 129 is provided between an outer surface of the piston 121 and an inner surface of the cylinder 121 in order to prevent leakage of the brake oil flowing into the cylinder 121. In addition, the sealing element 129 functions to return the piston 124 to an original position when braking is released.

The spindle unit 130 receives rotational force from the actuator 130 which includes a motor (not shown) and a speed reducer (not shown), and pressurizes the piston 124 to move toward the inner pad plate 111. The spindle unit 130 includes a nut 134 which is disposed in the piston 124 and is in contact with the piston 124, and a screw 132 which is screw-engaged with the nut 134.

The screw 132 penetrates the rear portion of the caliper housing 120, i.e., the cylinder 121, and is arranged in parallel with a direction of movement of the nut 134. The screw 132 rotates at a fixed position in the cylinder 121. The screw 132 is formed with a screw thread for screw-engagement with the nut 134 at a portion thereof. The other portion of the screw 132 is supported by a bearing 138 for smooth rotation and is coupled to the actuator 140 to receive rotational force therefrom.

The nut 134 is disposed in the piston 124 and is restricted in rotation. The nut 134 is screw-engaged with the screw 132. Accordingly, the nut 134 moves forward and backward depending upon a rotating direction of the screw 132, thereby pressurizing the piston 124 and releasing pressurization. The nut 134 includes a head part 134a which contacts the piston 124 and a rod 134b which extends from the head part 134a and is formed with a screw thread at an inner peripheral surface thereof so as to be screw-engaged with the screw 132. The head part 134a and the rod 134b are formed integrally with each other.

The above-structured electric caliper brake 100 further comprises an elastic element 160 and a fixing element 150 to support the elastic element 160 in order to solve a drag problem by securely returning the piston 124 to an original position when braking is released.

The elastic element 160 is disposed in the piston 124. The fixing element 150 is fixedly mounted in the piston 124 in order to prevent the elastic element 160 disposed in the piston 124 from being separated from the piston 124. As shown in the drawings, the fixing element 150 is fixed to a rear inner peripheral surface of the piston 124 and supports the elastic element 160. In order that the fixing element 150 is fixed to the piston 124, a fixing groove 125 is formed along a rear inner peripheral surface of the piston 124. That is, the fixing element 150 is fitted into the fixing groove 125. The fixing element 150 may be a circlip.

Meanwhile, when the elastic element 160 is assembled through the fixing element 150, the fixing element 150 is coupled to the piston 124 in a state of having the elastic element 160 disposed at a rear side of the nut 134, thereby ensuring an easy assembly of the elastic element 160.

As described above, the elastic element 160 functions to return the piston 124 to an original position. In detail, one end of the elastic element 160 is supported by a rear wall of the head part 134a of the nut 134, and the other end of the elastic element 160 is supported by the fixing element 150. The elastic element 160 disposed in the piston 124 surrounds the rod 134b with a gap therebetween. When a brake oil pressure or pressurization by the nut 134 is released after braking is completed, the elastic element 160 forcibly rolls back the piston 124 to an original position using elastic restoring force thereof. The operation of the elastic element 160 to return the piston 124 will be described later.

The elastic element 160 may be a wave spring. The wave spring 160 has a structure in which wave crest portions and wave trough portions are alternately formed. The wave spring 160 may be formed by connecting plural ring-shaped springs or being wound in a coil shape. Depending upon arrangement between the wave crest portions and the wave trough portions which oppose each other or arrangement between the wave crest portions and the other wave crest portions which oppose each other, the wave spring 160 selectively realizes a linear load-displacement relationship or a nonlinear load-displacement relationship. The wave spring 160 has greater accumulated energy per unit area (elastic restoring force) than a typical coil spring, and has a feature of obtaining large movement in spite of a short stroke.

The elastic element 160 is fixed to the piston 124 by the fixing element 150 while being compressed to a predetermined extent. Therefore, the elastic element 160 rapidly moves in cooperation with the piston 124 and the spindle unit 130 according to movement of the piston 124 by oil pressure and the spindle unit 130 or according to compression of the elastic element 160 by the spindle unit 130.

The operation of the electric caliper brake structured as above will now be described with reference to FIGS. 3 through 5.

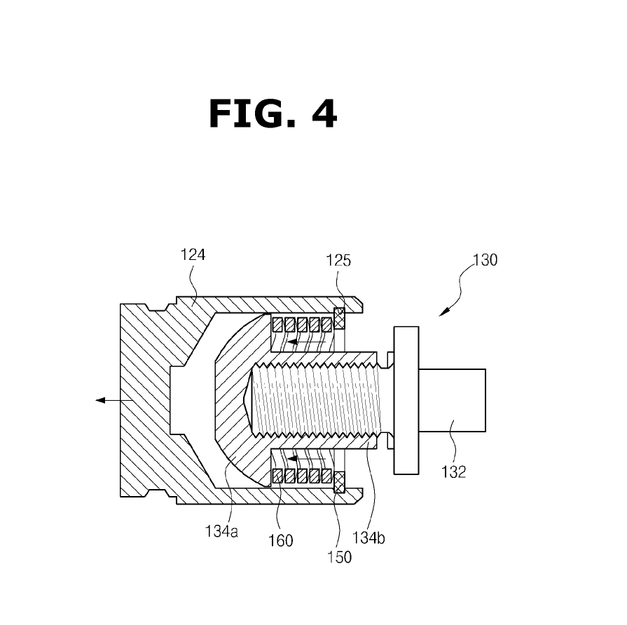

First, as shown in FIG. 3, if a driver presses a brake pedal (not shown) of a vehicle when the pad plates 111 and 112 are in a separated state from both lateral surfaces of the disc D (i.e., a non-braking state), a brake oil pressure generated from a master cylinder (not shown) is transmitted into the cylinder 121 through the oil port 128, and thus the piston 124 moves forward by the brake oil pressure. As shown in FIG. 4, the piston 124 moving forward pressurizes the inner pad plate 111, and the caliper housing 120 moves by reaction force to pressurize the outer pad plate 112 toward the disc D, thereby achieving braking operation to decelerate or stop the vehicle. When the piston 124 moves forward, the fixing element 150 fixed to the piston 124 moves together with the piston 124 and pressurizes the elastic element 160. At this time, because the spindle unit 130 is in a fixed state, an end of the elastic element 160, which is supported by the nut 134, cannot move. Accordingly, the elastic element 160 is compressed.

If the brake oil pressure is removed when braking is released, the piston 124 is returned to an original position by elastic restoring force of the elastic element 160. That is, the elastic element 160 forcibly rolls back the piston 124. Accordingly, even though the sealing element 129 fails to roll back the piston 124, a drag phenomenon is prevented.

Next, the operation of the piston when parking braking operation is carried out and the parking braking operation is released will be described.

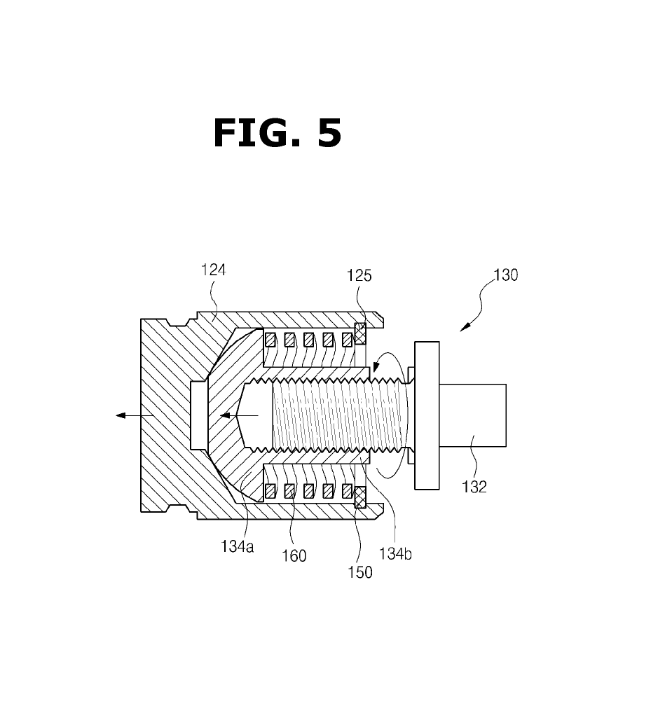

If a driver manipulates a control device (not shown), e.g., presses a parking switch (not shown), to carry out parking, the actuator 140 generates driving force according to an input signal and transmits the driving force to the spindle unit 130. As shown in FIG. 5, as the screw 132 of the spindle unit 130 rotates, the nut 134 screw-coupled to the screw 130 moves and pressurizes the piston 121. Accordingly, the piston 121 pushes the inner pad plate 111 toward the disc D, and simultaneously the caliper housing 120 slides and pressurizes the outer pad plate 112 to contact the disc D, thereby achieving braking operation. At this time, because the nut 134 moves forward together with the piston 124 in a contact state with the piston 124 and the fixing element 150 fixed to the piston 124 moves with the piston 124, the elastic element 160 supported between the nut 134 and the fixing element 150 also moves with the piston 124.

When the parking braking operation is released, rotational force generated from the actuator 130 is exerted in an opposite direction to when the parking braking operation is carried out. Accordingly, the screw 132 rotates in an opposite direction to when the parking braking operation is carried out, and thus the nut 134 moves to an original position. At this time, when the nut 134 moves, the nut 134 pressurizes the elastic element 160 supported by a rear wall of the nut 134, and the elastic element 160 pressurizes the fixing element 150 supported by the other end of the elastic element 160. Accordingly, the piston 124 is forcibly returned to an original position by elastic force of the elastic element 160.

As is apparent from the above description, when a brake oil pressure is removed or the nut 134 is returned after braking is completed, the elastic element 160 forcibly rolls back the piston 124 to an original position using elastic force thereof, thereby preventing a drag phenomenon which may occur due to malfunction of the sealing element 129.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. An electric caliper brake including a carrier to which a pair of pad plates configured to move forward and backward are mounted, and a caliper housing which is slidably mounted to the carrier and is provided with a cylinder containing a piston configured to move linearly by a brake oil pressure, the electric caliper brake comprising:
a spindle unit including a screw which penetrates a rear portion of the cylinder and is configured to rotate by receiving rotational force from an actuator, and a nut which is screw-engaged with the screw in the piston and configured to move forward and backward according to rotation of the screw while being restricted in rotation so as to pressurize the piston and release pressurization;
a fixing element fixed to a rear inner peripheral surface of the piston; and
an elastic element having one end supported by the nut and the other end supported by the fixing element, and configured to return the piston to an original position when braking is released,
wherein when the piston moves by a brake oil pressure, the elastic element is compressed against the spindle unit which is kept stationary, and
when braking is released, the elastic element returns the piston using elastic restoring force thereof.

2. The electric caliper brake according to claim 1, wherein the nut includes a head part which contacts the piston and a rod which extends from the head part and is formed with a screw thread at an inner peripheral surface thereof so as to be screw-engaged with the screw, and
the one end of the elastic element is supported by a rear wall of the head part, and the elastic element surrounds the rod.

3. The electric caliper brake according to claim 1, wherein when the nut of the spindle unit moves forward and pressurizes the piston, the elastic element moves together with the piston, and
when the nut moves backward, the elastic element is pressurized by the nut and returns the piston using elastic restoring force thereof.

4. The electric caliper brake according to claim 1, wherein the piston is formed with a fixing groove along a rear inner peripheral surface thereof, and
the fixing element is a circlip which is fitted into the fixing groove in order to prevent the elastic element from being separated from the piston.

5. The electric caliper brake according to claim 1, wherein the elastic element is a wave spring.
